(19) United States
(12) Patent Application Publication
(10) Pub. No.: US 2010/0266406 A1
(43) Pub. Date: Oct. 21, 2010

(54) Turbine Arrangement

(76) Inventor: Jan Inge Eielsen, Hafrsfjord (NO)

Correspondence Address: GABLE & GOTWALS, 100 WEST FIFTH STREET, 10TH FLOOR, TULSA, OK, 74103, US

(21) Appl. No.: 12/747,663

(22) PCT Filed: Jan. 19, 2009
(86) PCT No.: PCT/NO2009/000022

§ 371 Date: Jun. 30, 2010

(30) Foreign Application Priority Data
Jan. 24, 2008 (NO) 20080454

(51) Int. Cl. F03B 17/06

(52) U.S. Cl. 416/84

(57) ABSTRACT

A turbine arrangement for extracting energy from flowing water, the turbine arrangement s including a screw turbine with a suspension means, buoyancy element and bottom mount, and necessary transmission elements for transmitting energy to a power machine, and the turbine arrangement including at least two parallel screw turbines.

### CROSS REFERENCE TO RELATED APPLICATIONS

This application is the U.S. National Phase of PCT Application No. PCT/NO2009/000022 filed 19 Jan. 2009 which claims priority to Norwegian Patent Application No. 20080454 filed 24 Jan. 2008 both of which are incorporated herein by reference.

### STATEMENT REGARDING FEDERALLY SPONSORED RESEARCH

Not Applicable

### THE NAMES OF THE PARTIES TO A JOINT RESEARCH AGREEMENT

Not Applicable

### In REFERENCE TO A SEQUENCE LISTING

Not Applicable

### BACKGROUND OF THE INVENTION

This invention relates to a turbine arrangement. More particularly, it relates to a turbine arrangement for extracting energy from flowing water, the turbine arrangement including a screw turbine with a suspension means, buoyancy element and bottom mount and also necessary transmission elements for transmitting energy to a power machine.

It is well known that, for example, tidal flows contain considerable amounts of energy. However, it has turned out to be connected with considerable challenges to extract energy of some significance from tidal flows.

According to the prior art, so-called tidal mills are used, in which a structure resembling a wind mill is placed on the seabed. The blades of the tidal mill sweep a relatively large area. Considerable forces arise, which must be absorbed by a large and heavy tower structure. Some prior art tower structures also project above the sea surface, which may have a disfiguring effect and be a hindrance to shipping.

The invention has for its object to remedy or reduce at least one of the drawbacks of the prior art.

### BRIEF DESCRIPTION OF THE INVENTION

A turbine arrangement is provided for extracting energy from flowing water, the turbine arrangement including a screw turbine with a suspension means, buoyancy element and bottom mount, and also necessary transmission elements for transmitting energy to a power machine, and the turbine arrangement including at least two parallel screw turbines.

An aspect of the turbine arrangement is that adjacent screw turbines are of opposite pitches and are arranged to overlap each other. A transmission connection between the adjacent screw turbines ensures that the screw turbines will rotate at the same speed.

The adjacent screw turbines may thereby be spaced apart by a center distance which is smaller than the diameter of the screw turbines, which reduces the flow opening between the screw turbines. This condition provides for improved utilization of the flowing water. The two screw turbines rotate in opposite directions and are therefore affected symmetrically by the flowing water.

The power machine may be arranged coaxially with the center axis of the screw turbine, for example, or in another position. The rotational speed of the power machine relative to the screw turbine can be determined by means of the transmission ratio of the transmission transmitting the energy from the screw turbine to the power machine.

Another aspect of the turbine arrangement is that it is rotatably connected to the bottom mount. The turbine arrangement thereby aligns itself with the direction of flow of the water. Besides, the turbine arrangement takes an angle relative to the horizontal plane which is favourable in relation to the pitch of the screw turbine. The angle is controlled by adjusting the buoyancy of the turbine arrangement to the flow force to which the turbine assembly is subjected.

A further aspect of the turbine arrangement is that the buoyancy element is constituted by the screw turbine. For example, the screw turbine is manufactured at least partially of a material which has a lower density than water.

Yet another aspect of the turbine arrangement is that the bottom mount is formed with a quick coupling for the turbine arrangement. Thereby, with the exception of the bottom mount, the turbine arrangement is arranged to be detached relatively easily and be moved between the bottom mount and the surface, for example along one or more guide cables.

The bottom mount can be constituted by a foundation of a construction known per se, for example a suction anchor. The bottom mount is provided with the necessary couplings for transmitting energy from the power machine. With advantage, the power machine is constituted by an electric generator, but may also be constituted by a pump, for example.

It is possible to maintain a desired angle between the screw turbine and the horizontal plane by controlling the power output of the power machine, wherein a reduced power output will have the effect of the buoyancy, which seeks to pivot the turbine arrangement into a vertical position, pivoting the turbine arrangement into a larger angle relative to the horizontal plane.

By the fact that the turbine arrangement is kept suspended by means of buoyancy and aligns itself with the direction of flow, the bottom mount is subjected to insignificant torques. The forces transmitted to the bottom mount are formed in the main by tensional forces from the suspension.

The water flowing towards the portions of the screw turbine facing the water flow at any time exerts a pressure on the screw turbine. The flowing water principally sets up a pressure against the portions of the screw turbines which are on the outside of the center axis of the screw turbine relative to the adjacent screw turbine. By this cooperation between two screw turbines there will be a symmetry in the power distribution which brings the turbine arrangement to align itself in a favourable manner with the direction of flow.

With advantage, the cross section of the screw turbine is given an aerofoil profile. Water flowing along the screw turbine thereby subjects the aerofoil profile to a lifting force, a component of the lifting force seeking to rotate the screw turbine around the turbine axis of the screw turbine.

In relation to the prior art, the turbine arrangement according to the invention provides a substantial simplification of the task of extracting energy from flowing sea water. The construction is considerably simpler because the bottom mount is not subjected to bending moments. The turbine arrangement according to the invention is also well suited for use in relatively shallow regions and could thereby conceivably also be used in river courses.

### BRIEF DESCRIPTION OF THE DRAWINGS

In what follows is described an example of a preferred embodiment which is visualized in the accompanying drawings, in which:

FIG. 1 shows schematically a turbine arrangement in accordance with the invention;

FIG. 2 shows schematically a side view of the turbine arrangement;

FIG. 3 shows schematically an end view II-II of FIG. 2; and

FIG. 4 shows a section of a screw turbine.

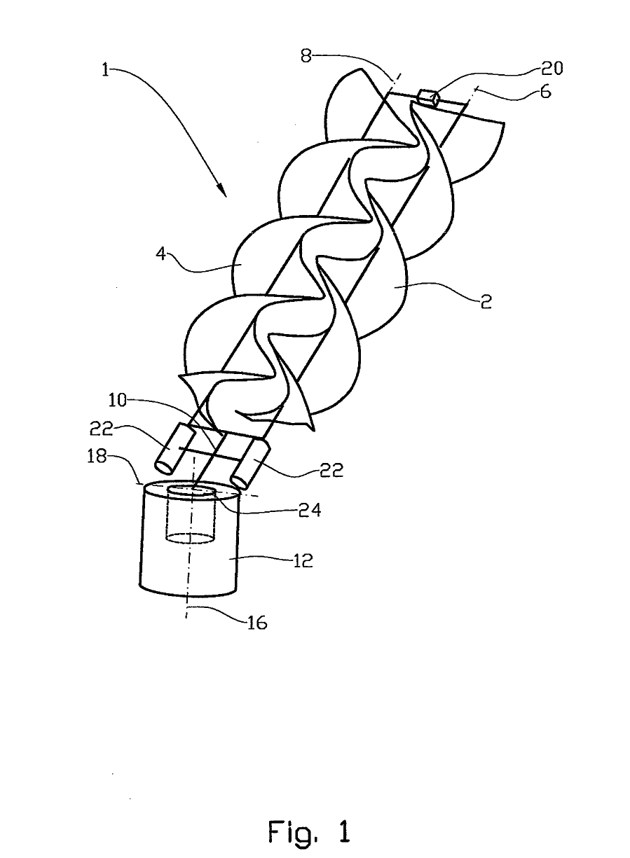

### DETAILED DESCRIPTION OF THE INVENTION

In the drawings, the reference numeral 1 indicates a turbine arrangement comprising a first screw turbine 2 and a second screw turbine 4. The screw turbines 2, 4 are rotatable around, respectively, a first turbine axis 6 and a second turbine axis 8.

The screw turbines 2, 4 are supported in a suspension means 10 which is connected to a bottom mount 12 which is placed in the seabed 14. The suspension means 10 is rotatable around a vertical axis 16 relative to the bottom mount 12 and around a rotatable horizontal axis 18.

The two screw turbines 2, 4, which are of opposite pitches and rotate in opposite directions of rotation, are connected to each other by means of a transmission 20.

Each of the screw turbines 2, 4 is connected to a respective power machine 22 which is formed, in this preferred exemplary embodiment, by an electric generator. Necessary wiring is not shown.

A rotary suspension means 24 is arranged in the bottom mount 12. The rotary suspension means 24 is arranged to be locked in a relatively simple manner, known per se, to the bottom mount 12 and to be detached from the bottom mount 12 to be moved between the bottom mount 12 and the surface by means of guide cables, not shown.

A cross section 26 of the first screw turbine 2 is shown in FIG. 4. The cross section 26 is given an aerofoil profile which brings water, which is flowing approximately parallel to the cross section 26, to apply a lifting force to the first screw turbine 2, resulting in a torque around the first turbine axis 6.

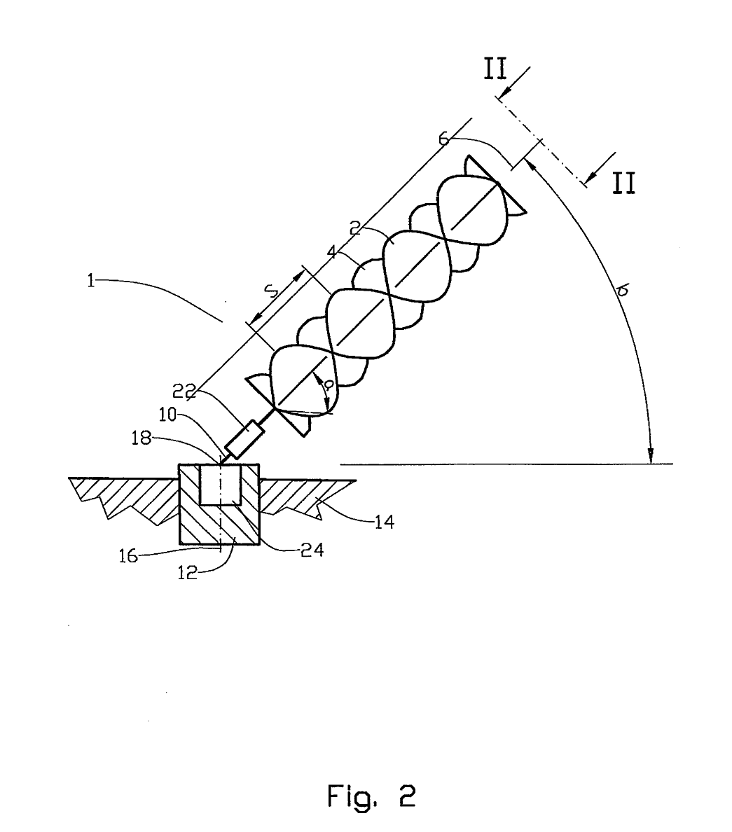

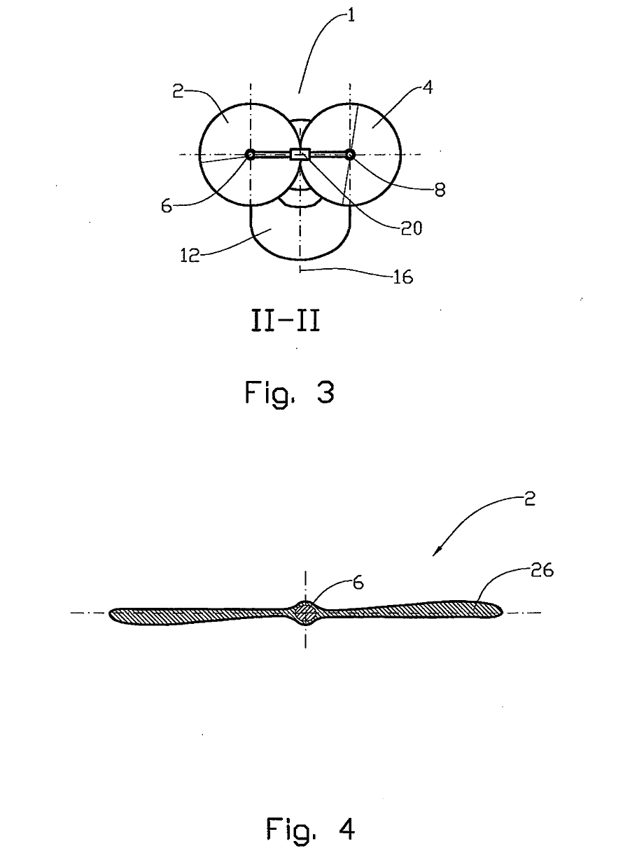

The screw turbines 2, 4 are formed with a pitch “S” resulting in a pitch angle “a”, see FIG. 2.

The screw turbines 2, 4 are formed in a relatively light material and are thus provided with buoyancy.

When the water surrounding the turbine arrangement 1 is stagnant, the buoyancy of the screw turbines 2, 4 will seek to adjust the turbine arrangement 1 around the horizontal axis 18 so that the turbine axes 6, 8 take a vertical direction.

As the water flow increases, the turbine arrangement 1 adjusts in relation to the direction of flow by rotating around the vertical axis 16. At the same time, the flow forces seek to pivot the turbine-turbine arrangement 1 around the horizontal axis 18 so that the turbine axes 6, 8 take an angle “b” to the horizontal plane, see FIG. 2.

Preferably, the angle “b” approximately equals the pitch angle “a”.

The flow force from the flowing water affecting the screw turbines 2, 4 bring the screw turbines 2, 4 to rotate around their respective turbine axes 6, 8, whereby energy is transmitted to the power machines 22.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

1. A turbine arrangement for extracting energy from flowing water, said turbine arrangement comprising: a screw turbine with a suspension means, buoyancy element and bottom mount, and necessary transmission elements for transmitting energy to a power machine, the turbine arrangement including at least two parallel screw turbines, and wherein two adjacent screw turbines have opposite pitches and overlap each other

2. The device in accordance with claim 1, wherein the buoyancy element is constituted by the screw turbine.

3. The device in accordance with claim 1, wherein the turbine arrangement is rotatably connected to the bottom mount.

4. The device in accordance with claim 1, wherein that the bottom mount is formed with a quick coupling for the turbine arrangement.

5. The device in accordance with claim 1, wherein the turbine arrangement is designed to be movable between the surface and the seabed.

6. The device in accordance with claim 1, wherein that the cross section of the screw turbine is given an aerofoil profile.
